(19) United States
(12) Patent Application Publication
(10) Pub. No.: US 2026/0046026 A1
(43) Pub. Date: Feb. 12, 2026

(54) MAINTAINING LINE-OF-SIGHT IN WIRELESS HYBRID MOBILE MESH NETWORKS

(71) Applicant: SpaceRake, Inc., Cambridge, MA (US)

(72) Inventors: Jordan Wachs, Concord, MA (US); Weston A. Marlow, Lanesborough, MA (US); Brian Mathason, Lexington, MA (US); Sanjay Khatri, Medford, MA (US); Avinash Uttamchandani, Somerville, MA (US); Jeremy W. Wertheimer, Brookline, MA (US); Paul Serra, Cambridge, MA (US); Kerri L. Cahoy, Concord, MA (US); Patrick Kage, Glastonbury, CT (US)

(73) Assignee: SpaceRake, Inc., Cambridge, MA (US)

(21) Appl. No.: 19/365,256

(22) Filed: Oct. 22, 2025

Related U.S. Application Data
(60) Provisional application No. 63/071,088, filed on Aug. 27, 2020.

(51) Int. Cl. H04B 10/112; H04W 24/04

(52) U.S. Cl. CPC H04B 10/112; H04W 24/04

(57) ABSTRACT

A wireless mesh data network composed principally of Unmanned Aerial Vehicle (UAV)-platformed nodes intercommunicating via hybrid links utilizing Radio Frequency (RF) and/or Free Space Optical (FSO) data communications, and provided with novel features and capabilities for acquiring, maintaining, and recovering Line-Of-Sight (LOS) between communicating nodes. FSO communications are preferred for high bandwidth and security, but it is not always possible to provide Line-Of-Sight (LOS) between communicating nodes, as required by FSO, because of obstruction by natural and artificial features of the environment. The provided novel features and capabilities of the invention optimize and enhance the overall network LOS status.

### CROSS REFERENCE TO RELATED APPLICATIONS

This application claims the benefit of U.S. Ser. No. 63/710,088, filed on Oct. 22, 2025 which is/are incorporated in their entirety herein by reference.

### FIELD

The present invention relates to communication networks, specifically to mobile wireless mesh networks utilizing both free-space optical (FSO) and radio frequency (RF) communication modes.

### BACKGROUND

Mobile mesh communication networks offer modern communication systems flexibility, redundancy, and ability to scale across various platforms and applications in a variety of environments. Traditional wireless mobile mesh networks primarily rely on radio frequency (RF) communication, which is often susceptible to interference, bandwidth limitations, and range constraints. Free-Space Optical (FSO) communication offers a high-bandwidth, secure alternative, but is limited to line-of-sight (LOS) communications and by environmental conditions such as fog, rain, or smoke. Unfortunately, LOS communication between mobile nodes is vulnerable to obstructions from natural and artificial features of the environmental topography. It is therefore highly desirable to have a wireless mesh network for LOS node communications, such that the network is capable of configuring the respective positions (geographical locations) of the mobile nodes to acquire, maintain, and recover LOS between the nodes in environments with topographical features capable of obstructing LOS. This goal is attained by the present invention.

### SUMMARY

Embodiments of the present invention provide a mobile FSO/RF hybrid mesh communication network supporting nodes which communicate via FSO only, RF only, and hybrid nodes capable of both FSO and RF communication, and which are capable of anticipating, avoiding, and recovering from loss of LOS communications between nodes due to changes in the locations of the nodes resulting in obstruction by features of the environmental topology. Embodiments of the present invention are principally concerned with network nodes aboard Unmanned Aerial Vehicles (UAVs), especially UAVs capable of Vertical Takeoff and Landing (VTOL) which are equipped with avionic systems, of the class commonly referred to as “drones”. Although networks according to embodiments of the invention are primarily aerial with three degrees of positional freedom for nodes, various embodiments may also include nodes aboard satellites in predetermined earth orbits, nodes installed on mobile surface-based vehicles (with two degrees of positional freedom), as well as nodes in stationary ground-based structures (with no degrees of positional freedom).

According to embodiments of the present invention, the positions of mobile nodes can be dynamically reconfigured to provide, maintain, and restore LOS communications to optimize link bandwidth, quality, network coverage, and/or security.

Embodiments of the present invention are beneficial in various industries and sectors, including but not limited to: military and defense; disaster recovery; remote surveillance and monitoring systems; and space-based communication networks.

### BRIEF DESCRIPTION OF THE DRAWINGS

The subject matter disclosed may best be understood by reference to the following detailed description when read with the accompanying drawings in which:

FIG. 1 conceptually illustrates a mobile hybrid mesh network according to an embodiment of the present invention.

FIG. 2 illustrates a repositioning of a mobile node of a network to circumvent an obstruction that has disrupted LOS communications with another node of the network, according to an embodiment of the present invention.

FIG. 3 illustrates a predictive positioning of a mobile node of the network to avoid an obstruction that could disrupt LOS communications with another node of the network, according to an embodiment of the present invention.

FIG. 4 illustrates the resources of the mesh network for positional-configuration and control of the mobile UAV node platforms for acquiring, maintaining, and recovering optimal LOS among the nodes, according to an embodiment of the present invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

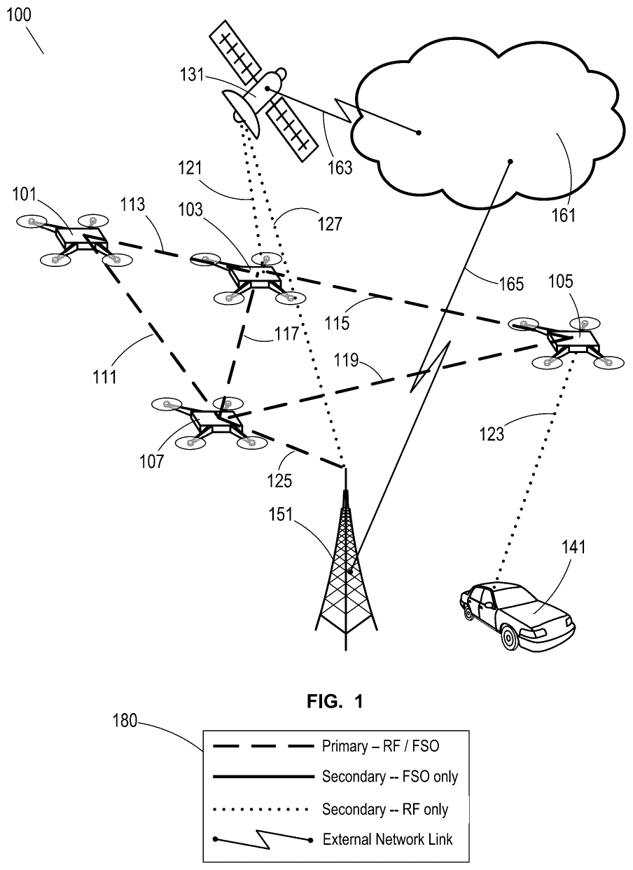

FIG. 1 conceptually illustrates a mobile hybrid mesh network 100 according to an embodiment of the present invention. Network 100 includes nodes 101, 103, 105, and 107, each of which is aboard a UAV platform capable of VTOL operation and provided with suitable avionic systems, network interfaces, and data communications apparatus for intercommunication over links 111, 113, 115, 117, and 119. Although network 100 is principally implemented on VTOL UAV platforms, in related embodiments, network 100 also includes a node 131 aboard a satellite in Low Earth Orbit (LEO) communicating with node 103 via a link 121, a node 141 aboard a terrestrial vehicle communicating with node 105 via a link 123, and a node 151 at a ground station communicating with node 107 via a link 125, and with satellite 131 via a link 127. Further, in a related embodiment, network 100 also includes non-VTOL UAV platforms. In addition, network 100 includes connections to an external network 161 (e.g., the Internet) such as via a link 163 to satellite-based node 131 and a link 165 to ground station-based node 151. External network 161 is not a part of network 100, but in various embodiments of the present invention, network 161 and network 100 are connected and may intercommunicate.

The modality of the communications supported by the nodes via the respective links is keyed to a legend 180.

Within the scope of the present invention, network 100 is primarily concerned with LOS among the UAV-based nodes. Although satellite-based node 131, terrestrial vehicle-based node 141, and ground-station-based node 151 may participate in LOS-related transactions (e.g., to provide data and other resources), they are not actively controlled according to the LOS control scheme discussed herein.

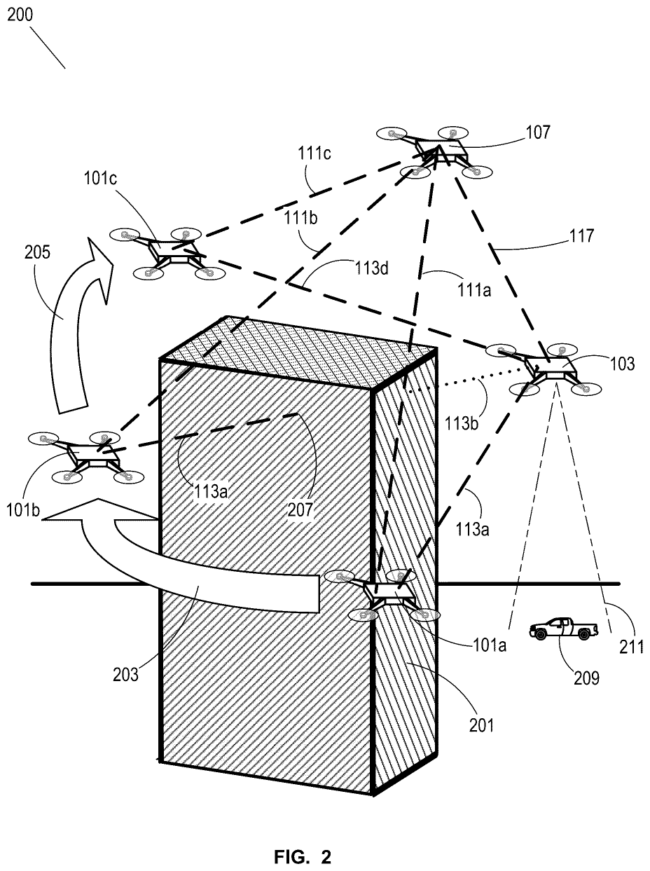

FIG. 2 illustrates a repositioning of mobile node 101 of the network shown in FIG. 1, to circumvent an obstruction 201 that has disrupted LOS communications between node 101 and node 103 of the network, according to an embodiment of the present invention. Three positions of node 101 are shown:
an initial position 101a communicating with node 103 via a link 113, shown in an initial orientation 113a;
an intermediate position 101b following a move 203 which has caused an interruption in LOS of link 113, resulting in a first segment 113a, which has been obstructed by a structure 201 at an intersection point 207, such that combined FSO communications of link segment 113a is blocked, and thus a link 113 second segment 113b is limited to RF communications (in practice, not only will FSO communications be blocked by an obstructing object, such as structure 201, but RF communications may be negatively impacted as well); and
a final position 101c following a move 205, which has been calculated by the network as a compensating move to recover LOS communication between node 101 and node 103 via link 111 which is now in an orientation 113d.

One of the considerations in choosing node 101 to make move 205, rather than choose node 103 to make a compensating move, is that (in this non-limiting example), node 103 has been assigned a priority task of carrying out a visual surveillance 211 of a subject 209, whereas node 101 is not assigned to remain in any particular location at this time. It is noted that even though node 101 in position 101b has lost LOS communications with node 103, node 101 still maintains full communications with node 107, and thus still has access to network 100 and the data resources thereof. Although node 101 can still communicate with node 103 (via network node-hopping across still-active LOS FSO links, and also via RF link), the quality of network 100 connectivity is degraded by the loss of LOS between node 101 and node 103. In this embodiment of the present invention, LOS is readily recovered in case of loss, to restore connection bandwidth and quality.

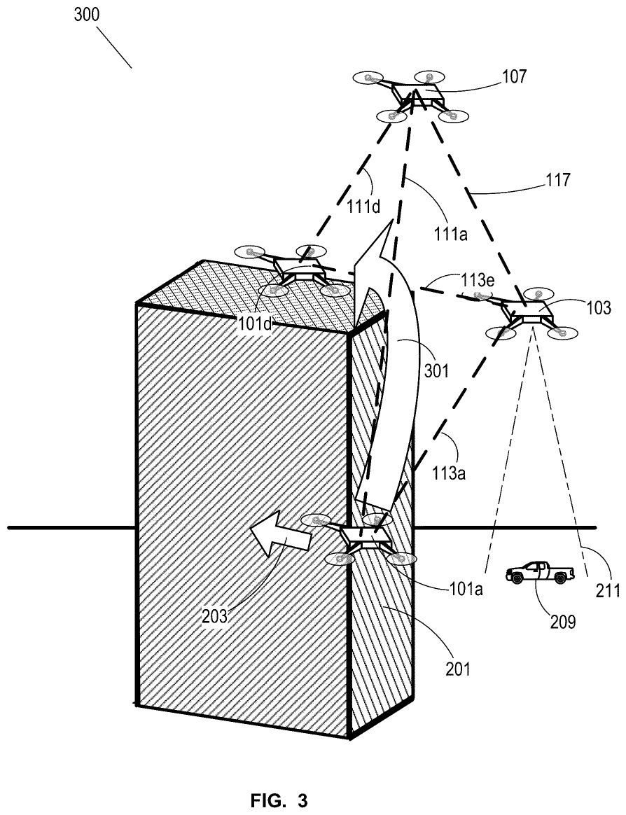

In another embodiment of the present invention, loss of LOS is predicted. FIG. 3 illustrates a predictive positioning 300 of mobile node 101 to avoid obstruction 201 that could disrupt LOS communications with another node in the network, according to an embodiment of the present invention. In this embodiment, mobile node 101 is initially moving in direction 203, but the network predictively calculates that if mobile node 101 continues moving in direction 203, then it will move into a position where it will lose LOS with mobile node 103 on account of obstruction by structure 201. The network assesses that mobile node 103 has a higher priority on its present position than mobile node 101 has on its present movement, and, to prevent loss of LOS between mobile node 101 and mobile node 103, the network re-directs mobile UAV platform of node 101 to move in a direction 301 instead, to a new position 101d, which avoids having structure 201 obstruct LOS between mobile node 101 and mobile node 103.

Predictively avoiding loss of LOS (as shown in FIG. 3) may be preferable to restoring LOS after loss of LOS (as shown in FIG. 2), because maintaining LOS is generally easier than having to reacquire LOS after loss. Nevertheless, it may not always be possible to predict loss of LOS, or to prevent loss of LOS, and therefore the network should be able to handle both maintenance and recovery of LOS.

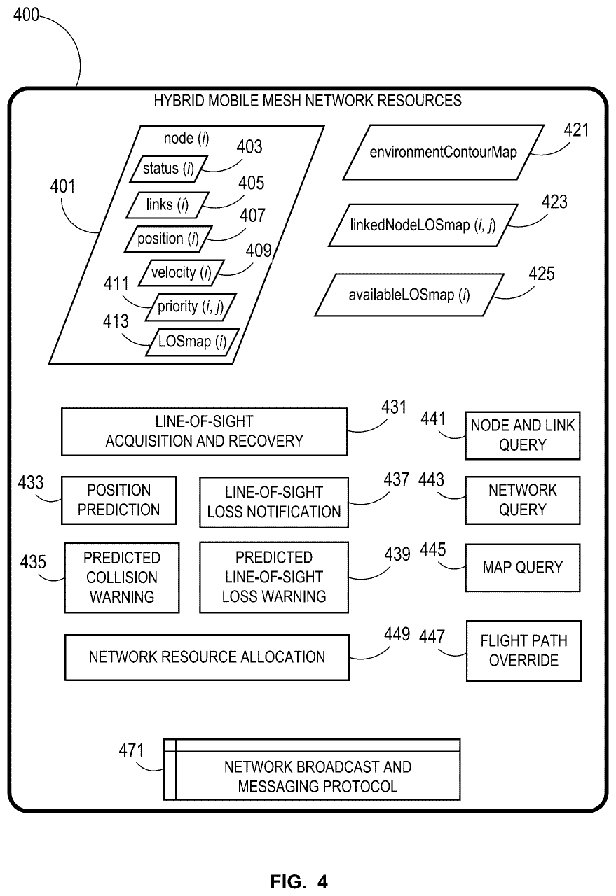

FIG. 4 illustrates resources 400 of mesh network 100 (FIG. 1) for positional configuration and control of the mobile nodes for acquiring, maintaining, and recovering optimal LOS among the nodes, according to an embodiment of the present invention. As with networks in general, mobile mesh network 100 provides a number of data resources for coordinated use by individual nodes as well as groups of nodes working together. As shown in FIG. 4, the resources include data storage resources as well as data processing resources.

Among the data storage resources of network 100 according to an embodiment of the present invention, is a node status data storage resource 401 which includes data for all the nodes, denoted in general as node (i), where the integer i ranges from 1 to N, the number of nodes generally in network 100. More specifically, this data includes, but is not limited to:
status (i) 403, which stores the data indicating the health and status of node (i), including, but not limited to transmit/receive component condition for both RF and FSO data communications; processor condition and temperature, available memory; and performance issues and flight status of the UAV platform of node (i), e.g., battery charge, avionics readiness, etc.
links (i) 405, which stores data about the active communication links of node (i), including data rates, signal-to-noise ratio, connection times, quality, and stability, etc.;
position (i) 407, which stores the global position vector (including altitude) of the UAV platform of node (i);
velocity (i) 409, which stores the velocity vector (relative to stationary) of the UAV platform of node (i);
priority (i, j) 411, which stores the assigned positional priority of node (i) relative to a different node (i) in the event that the relative positions of two nodes must be adjusted, positional priority indicates whether which node UAV should be moved—that of node (i) or that of node (j)—or whether both node UAVs should be moved, and if so, by what relative amounts;
LOSmap (i) 413, which stores a data description of the space around node (i) where there is LOS to and from node (i). Nominally, this would be in terms of a spherical coordinate system specifying the θ and φ angular directions in which node (i) has LOS to the outer periphery of network 100, including the linear extent r of the LOS, which is limited in r wherever there is an obstructive feature of the environment, in which case r is simply the linear distance from node (i) to the obstructive feature.
It is noted that the r, 0, and @ spherical coordinates are readily converted to Cartesian coordinates, and vice-versa, by well-known and well-supported devices, and, in a related embodiment of the present invention, by coordinate data processing resources (not illustrated) of network 100.

In addition to the node-related data storage resources listed above, embodiments of the present invention provide the following data storage resources related to network 100 as a whole:
An environmentContourMap 421 stores data representing the environment of network 100, including all the natural features (e.g., hills and mountains, valleys, dunes, cliffs, chasms, bodies of water, trees and forests, etc.) and artificial features (e.g., buildings, bridges, elevated highways, walls, towers, chimneys, signage, monuments, and other structures) of the environment, notably features capable of obstructing LOS. The term “contour map” herein denotes a topographical map including contour lines representing the intersection lines of an (imaginary) elevated plane with the terrain and other features of the environment. Associated with each contour line is the altitude of the elevated plane in which the contour line lies. According to embodiments of the present invention, the contour map is rendered as a data object in a format which is compatible with all the individual resources 400 of network 100. In particular, the data processing resources of network 100 are capable of transforming parts of, or the entirety of, environmentContourMap 421 from its native format into a 3-dimensional wire-frame data representation of the environment in which network 100 is operating.
According to a related embodiment, this wire-frame representation is data-equivalent to environmentContourMap 421, and in another related embodiment, environmentContourMap 421 is rendered directly in a 3-dimensional wire-frame data format.
A linkedNodeLOSmap (i, j) 423 is a submap of the environment data in environmentContourMap 421, containing the regions of the environment which correspond to Lines-Of-Sight common to both node (i) and to node (i), where node (i) and node (i) are connected, or are intended to be connected via an FSO communication link. In geometrical set terminology, linkedNodeLOSmap (i, j) 423 is the intersection of LOSmap (i) 413 with LOSmap (/) 413.
An availableLOSmap (i) 425 is another submap of the environment data in environmentContourMap 421, containing the regions of the environment which correspond to Lines-Of-Sight common to node (i) and also common to all other nodes to which node (i) is connected, or is intended to be connected via FSO communication links. In geometrical set terminology, availableLOSmap (i) 425 is the iterative intersection of LOSmap (i) 413 with all LOSmap (/) 413, where (/) ranges over all values such that node (i) and node (i) are, or are intended to be connected together via an FSO communication link. The significance of availableLOSmap (/) is that it indicates all positions where the UAV of node (i) can be located and still maintain all existing and intended LOS FSO communication links.

According to certain embodiments of the present invention, all data storage resources for network 100, are continuously updated in real time. This includes, but is not limited to node status data resource 401 (status (i) 403; links (i) 405; position (i) 407; velocity (/) 409; priority (i, j) 411; LOSmap (i) 413); and in addition, environmentContourMap 421 as well as linkedNodeLOSmap (i, j) 423, along with availableLOSmap (i) 425. Thus, any query made at any time via network 100 for any of these elements in data storage will always return a currently valid data response.

According to embodiments of the present invention, among the data processing resources of network 100 is a Line-Of-Sight Acquisition and Recovery Service 431, which receives input arguments (i, j), specifying both node (i) and node (i) as the nodes which need to acquire or recover LOS between them. Line-Of-Sight Acquisition and Recovery Service 431 utilizes other data processing resources (as disclosed herein) along with a Flight Path Override module 447 (discussed in detail below) to position one or more UAV node platforms to effect the acquisition or recovery of LOS between node (i) and node (i). In particular Line-Of-Sight Acquisition and Recovery Service 431 is responsive to a predicted loss of Line-Of-Sight warning (as described below), and is capable of utilizing Flight Path Override module 447 to maintain LOS between node (i) and node (i). In a related embodiment, if node (i) and node (i) currently have LOS connectivity, then Line-Of-Sight Acquisition and Recovery Service 431 confirms this status, and cancels any active predicted loss of Line-Of-Sight warning.

According to embodiments of the present invention, among the data processing resources of network 100 is a Position Prediction Service 433, which receives an input (/) specifying the UAV of node (i), and computes an anticipated future vector position of the UAV based on the current vector position of node (i) extrapolated according to the current vector velocity of node (i) over a specified time interval Δt. It is noted that, in practice, UAV's can quickly accelerate and quickly change direction, so the velocity of node (i) may in those cases be valid only for a short amount of time. Nevertheless, Position Prediction Service 433 can provide valuable information in those cases where velocity is roughly constant over a period of time.

According to embodiments of the present invention, among the data processing resources of network 100 is a Predicted Collision Warning Service 435. Based on data provided by Position Prediction Service 433 for all nodes, along with data provided by environmentContourMap 421, Predicted Collision Warning Service 435 provides a warning of an anticipated collision between one or more nodes as well as a warning of an anticipated collision between nodes and features of the environment (such as buildings). As detailed below, the warning is broadcast over network 100.

According to embodiments of the present invention, among the data processing resources of network 100 is a Line-Of-Sight Loss Notification Service 437, which continually queries the nodes of network 100 for their connectivity status, and issues a notification when an LOS FSO communication connection is unintentionally lost. The notification includes the (i, j) identities of the now-disconnected nodes. As detailed below, the notification is broadcast over network 100.

According to embodiments of the present invention, among the data processing resources of network 100 is a Predicted Line-Of-Sight Loss Warning Service 439. Similar to Predicted Collision Warning Service 435, Predicted Line-Of-Sight Loss Warning Service 439 invokes Position Prediction Service 433 for all nodes i currently supporting LOS FSO communication, and queries availableLOSmap (i) data resources along with Position Prediction Service 433 to determine if any one or more of nodes/is predicted to leave a region supporting LOS connectivity with one or more other nodes. If the predicted position of a node/would be outside a region of LOS with another node j, then Predicted Line-Of-Sight Loss Warning Service 439 signals a Predicted Line-Of-Sight Warning to that effect over network 100, such as via broadcast, as described below. In an embodiment of the invention, when there is a predicted Line-Of-Sight loss warning, Line-Of-Sight acquisition and recovery service attempts to maintain LOS and prevent loss of LOS. The term “acquire” and the like in the context of LOS herein denotes not only initially establishing LOS but also maintaining LOS by preventing a loss condition, and also re-establishing LOS after a loss of LOS.

According to embodiments of the present invention, among the data processing resources of network 100 is a Node and Link Query Service 441, which provides convenient access to data resource 401 regarding data related to node (i) all nodes of network 100.

According to embodiments of the present invention, among the data processing resources of network 100 is a Network Query Service 443, which provides convenient access to all data resources related to network 100.

According to embodiments of the present invention, among the data processing resources of network 100 is a Map Query Service 445, which provides convenient access to all map-related data storage of network 100.

According to embodiments of the present invention, among the control resources aboard a node UAV platform is Flight Path Override module 447, which receives an input with a velocity vector to override and replace the present UAV velocity. If this request comes from Line-Of-Sight Acquisition and Recovery Service 431, then Flight Path Override Module 447 queries Node and Link Query Service 441 to determine if node (i) priority will allow its current flight path to accept the override request, and if so, to redirect the avionics control of the UAV with the replacement velocity. If this request comes from Predicted Collision Warning Service 435, in an embodiment of the present invention, the override applies regardless of node (i) priority.

According to embodiments of the present invention, among the network management resources of network 100 is a Network Resource Allocation Service 449, which assigns each of the resources of network 100 (including itself) to specific nodes. In a related embodiment each node is provided adequate data storage, program storage, and data processing capacity for accommodating all of the network resources 400. This provisioning is done for purposes of redundancy and fault-tolerance, so that network 100 will be assured of always having the required data resources and data processing resources necessary for proper functioning. However, even though each node may separately possess the hardware, firmware, and software for all the network data resources, it is not necessary or even desirable that every node provide for every data resource and every data processing resource. With the particular exception of Flight Path Override Module 447 (which is a component of each individual node), it is more efficient and less burdensome to distribute the operation of the data resources and the data processing resources across the network, while still providing the necessary redundancy and backup to provide that network 100 will be robust and fault-tolerant. The particular distribution of resources is performed by Network Resource Allocation Service 449, which assures sufficient redundancy and emergency backup. For example, if a specific node drops out of the network (such as by becoming inoperative), Network Resource Allocation Service 449 reassigns the resources from the now-missing or defunct node to appropriate other nodes. For this reason Network Resource Allocation Service 449 itself should be redundantly-operated on as many nodes as possible without imposing undue burdens on network 100.

According to embodiments of the present invention, interactions among the data storage resources and the data processing resources of network 100 are all performed in accordance with a Network and Broadcast Messaging Protocol 471. In this schema, a data processing resource invokes another data processing or data storage resource by placing a message on the network. A node which has been assigned to perform the requested data storage/retrieval service and/or the data processing service will then return the response to the sender of the message. In those cases where there are redundant nodes, there will be a priority sequence by which the redundant node(s) will wait before answering, and will answer only if the primary node for that service does not respond. In addition to sending messages to specific nodes, Network and Broadcast Messaging Protocol 471 also provides for general broadcast of notifications and warnings to all nodes at the same time.

In this manner, the maintenance of LOS connections according to the embodiments of the invention are reliably carried out via network 100 operating as an organic unit, with the various services and their required sub-services distributed evenly across network 100.

What is claimed is:

1. A wireless mesh network for Line-Of-Sight (LOS) node communication, the wireless mesh network comprising:
a plurality of mobile nodes in an environment, each of which is aboard an Unmanned Aerial Vehicle (UAV) platform capable of Vertical Takeoff and Landing (VTOL) operation and which includes a flight path override module operative to change a velocity of the UAV platform, wherein at least two nodes of the wireless mesh network have a communication capability limited to LOS;
a set of data resources available to nodes over the wireless mesh network, wherein the set of data resources includes:
an environment contour map storing data which represents features of the environment capable of obstructing LOS node communication; and
a Line-Of-Sight acquisition and recovery service, operative to position a UAV node platform according to data of the environment contour map and utilizing the flight path override module to acquire LOS.

2. The wireless mesh network of claim 1, wherein at least two nodes of the plurality of nodes communicate via Free-Space Optical (FSO) communications.

3. The wireless mesh network of claim 2, wherein at least two nodes of the plurality of nodes further communicate via Radio Frequency (RF) communications.

4. The wireless network of claim 1, wherein the set of data resources further includes:
a Line-Of-Sight loss notification service operative to signal a loss of Line-Of-Sight notification, wherein the Line-Of-Sight acquisition and recovery service is responsive to the loss of Line-Of-Sight notification to recover LOS.

5. The wireless network of claim 1, wherein the set of data resources further includes:
a position prediction service, for predicting the position of a UAV node platform; and
a predicted Line-Of-Sight loss warning service operative to receive a predicted UAV position and to signal a loss of Line-Of-Sight warning, wherein the Line-Of-Sight acquisition and recovery service is responsive to the loss of Line-Of-Sight warning to maintain LOS.

6. The wireless network of claim 1, wherein the set of data resources further includes:
an LOS map for a node, wherein the LOS map stores data relating to the space surrounding the node where there is LOS to and from the node, up to an outer periphery of the network.

7. The wireless network of claim 6, wherein the set of data resources further includes:
a linked node LOS map for a pair of nodes which are connected by an LOS data communication link, wherein the linked node LOS map stores data relating to the regions of the environment which correspond to Lines-Of-Sight common to both nodes of the pair of nodes.

8. The wireless network of claim 7, wherein the set of data resources further includes:
an available LOS map for a node, wherein the available LOS map stores data relating to all positions where the UAV platform of the node can be located while still maintaining LOS with all other nodes having LOS communication links to the node.
